(19) United States
(12) Patent Application Publication
(10) Pub. No.: US 2025/0343016 A1
(43) Pub. Date: Nov. 6, 2025

(54) LOAD BREAK DISCONNECT FOR GROUP OPERATED MULTI-PHASE SWITCHES

(71) Applicant: Southern Electrical Equipment Company, Inc., Charlotte, NC (US)

(72) Inventors: Andrew S. Panto, Waxhaw, NC (US); Barry Craig Thomas, Charlotte, NC (US); Doug Lanter, Richburg, SC (US); Dillon Surface, indian Trail, NC (US)

(21) Appl. No.: 19/270,733

(22) Filed: Jul. 16, 2025

Related U.S. Application Data
(63) Continuation-in-part of application No. 18/197,489, filed on May 15, 2023, now Pat. No. 12,400,812.
Application No. 18/197,489 is a continuation of application No. 17/358,462, filed on Jun. 25, 2021, now Pat. No. 11,688,572.
(60) Provisional application No. 63/046,250, filed on Jun. 30, 2020.

(51) Int. Cl. H01H 33/666; H01H 1/66; H01H 3/26; H01H 33/28; H01H 33/668

(52) U.S. Cl. CPC H01H 33/6661; H01H 1/66; H01H 3/26; H01H 33/28; H01H 33/666; H01H 33/668

(57) ABSTRACT

Various embodiments relate to an inline disconnect device for electrical transmission lines including a motorized cabinet comprising a power source, switch electronics, and a gear drive coupled to a disconnect blade having an interrupter bracket and catch. A ground-level control box with a wireless communication radio signals the switch electronics to protract or retract the disconnect blade via the gear drive. A load break vacuum interrupter housed within an interrupter housing includes vacuum bottles, a constant force spring, and guide rollers to permit axial movement of the vacuum interrupter from the housing upon disconnect blade retraction. The system enables remote-controlled load interrupting and safe isolation of transmission lines.

### CROSS-REFERENCE

This application is a continuation-in-part of and claims priority to U.S. application Ser. No. 18/197,489, filed on May 15, 2023, which further claims priority to U.S. Pat. No. 11,688,572 filed on Jun. 25, 2021, which further claims priority to and benefit of U.S. Provisional Patent Application No. 63/046,250, filed on Jun. 30, 2020, the entirety of which is incorporated by reference herein.

### FIELD

The present invention relates generally to group-operated switches for electric utility line applications, and more particularly to an inline disconnect for group-operated multi-phase switches that are not mechanically or electrically linked and incorporate interrupting and sensing devices that operate in an axial direction with the switches.

### BACKGROUND

Conventional electric utility lines are generally arranged wherein alternating currents of differing phases are carried on separate lines from point to point, each supported on the same pole. Each line carries a phase of alternating current (“AC”) that is offset, for example by 120° in a three-phase arrangement, from the others. These lines are arranged one over the other on the utility pole, a configuration that is described as “phase over phase.” These lines are generally under high tension between poles. At one or more poles along a given set of lines, a set of switches provides a means by which the electric utility may connect or disconnect the circuit. Such connects or disconnects may be a part of normal operation, or they may be used to facilitate repair work on the lines.

These switches are generally arranged to provide for connect or disconnect of all three phases as a group. Conventionally, the switches are operated by rotating the switch arms through a predetermined arc using a shaft that connects all three switch arms. This permits all the switches to be operated, i.e. opened or closed, simultaneously. This arrangement is enormously complicated for several reasons. Because the three lines must be kept electrically isolated from each other and from the switch operator, the operator shaft or disconnect member must be fully insulated. The switch arms must also be kept in correct alignment to operate correctly and reliably. This can present additional engineering challenges in real-world conditions, particularly at the installation stage. Load break devices such as vacuum interrupters and their associated operating linkages are mounted outside of the switch path causing electrical clearance issue. Site-specific application engineering is generally required, thus increasing installation time and expense for installation of load break devices. Additionally, the placement of group operated switches on a pole generally requires additional switch-related structures to be installed, in order to carry out the switching function.

There is a long-sought need for a load break disconnect for group-operated switches that are not mechanically or electrically linked, that permit easy installation on standard poles without specialized switch-related structures, and that do not require site-specific application engineering.

### SUMMARY

This summary is not an extensive overview of the invention. It is not intended to identify key or critical elements of the invention or to delineate the scope of the invention. In some aspects, the techniques described herein relate to an inline disconnect for electrical transmission lines, including: a motorized cabinet, including a power source, switch electronics, a gear drive connected to a disconnect blade for axial movement, the disconnect blade further including an interrupter bracket and catch; a control box at ground level, the control box including a wireless communication radio to signal to the switch electronics to protract or retract the disconnect blade with the gear drive; and a load break vacuum interrupter inside an interrupter housing, the load break vacuum interrupter including load break vacuum bottles and a constant force spring and guide rollers to allow the load break vacuum interrupter to move axially from the interrupter housing when the disconnect blade retracts.

In some aspects, the techniques described herein relate to an inline disconnect, wherein the switch electronics further include wireless transmission for communicating with the control box and for controlling the motorized cabinet.

In some aspects, the techniques described herein relate to an inline disconnect, wherein the disconnect blade with the interrupter bracket and catch holds the load break vacuum interrupter in electrical contact.

In some aspects, the techniques described herein relate to an inline disconnect, wherein the disconnect blade has multiple disconnect blade contact points for electrical connection.

In some aspects, the techniques described herein relate to an inline disconnect, further including a jaw contact on the interrupter housing for connecting with one of the disconnect blade contact points.

In some aspects, the techniques described herein relate to an inline disconnect, further including a terminal pad on the motorized cabinet.

In some aspects, the techniques described herein relate to an inline disconnect, further including a pull off, a pull off bracket, and an insulator.

In some aspects, the techniques described herein relate to an inline disconnect, wherein the power source for the gear drive is a battery.

In some aspects, the techniques described herein relate to an inline disconnect, wherein the disconnect blade is fully retracted and the interrupter is returned to the interrupter housing creates an air gap and a visual identifier of the disconnect of power.

In some aspects, the techniques described herein relate to an inline disconnect, wherein the disconnect blade catch is engaged with the load break vacuum interrupter and is released when the disconnect blade is fully retracted.

In some aspects, the techniques described herein relate to a method of deploying an inline disconnect for electrical transmission lines, including: providing a motorized cabinet, including a power source, switch electronics, a gear drive connected to a disconnect blade for axial movement, the disconnect blade further including an interrupter bracket and catch; providing a control box at ground level, the control box including a wireless communication radio to signal to the switch electronics to protract or retract the disconnect blade with the gear drive; providing a load break vacuum interrupter inside an interrupter housing, the load break vacuum interrupter including load break vacuum bottles and a constant force spring and guide rollers to allow the load break vacuum interrupter to move axially from the interrupter housing when the disconnect blade retracts; retracting axially the disconnect blade, which pulls the load break vacuum interrupter; and releasing the catch on the disconnect blade, allowing the load break vacuum interrupter to retract from the constant force spring back into the load break housing.

In some aspects, the techniques described herein relate to a method, wherein the switch electronics further include wireless transmission for communicating with the control box and for controlling the motorized cabinet.

In some aspects, the techniques described herein relate to a method, wherein the disconnect blade with the interrupter bracket and catch holds the load break vacuum interrupter in electrical contact.

In some aspects, the techniques described herein relate to a method, wherein the disconnect blade has multiple disconnect blade contact points for electrical connection.

In some aspects, the techniques described herein relate to a method, further including a jaw contact on the interrupter housing disengaging with one of the disconnect blade contact points, when the disconnect blade retracts.

In some aspects, the techniques described herein relate to a method, further including a terminal pad on the motorized cabinet.

In some aspects, the techniques described herein relate to a method, further including providing a pull off, a pull off bracket, and an insulator.

In some aspects, the techniques described herein relate to a method, wherein the power source for the gear drive is a battery.

In some aspects, the techniques described herein relate to a method, wherein when the disconnect blade is fully retracted and the load break vacuum interrupter is returned to the interrupter housing creates an air gap and a visual identifier of the disconnect of power.

In some aspects, the techniques described herein relate to a method, wherein the disconnect blade catch is engaged with the load break vacuum interrupter and is released when the disconnect blade is fully retracted.

### DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1A is a front perspective view of a single phase of an inline three-phase disconnect according to the present invention in the fully closed position;

FIG. 1B is front elevation view of FIG. 1A;

FIG. 2A is a front perspective view of a single phase of an inline three-phase disconnect according to the present invention in the 25% partially open position;

FIG. 2B is a front elevation view of FIG. 2A;

FIG. 3A is a front perspective view of a single phase of an inline three-phase disconnect according to the present invention in the 50% partially open position;

FIG. 3B is a front elevation view of FIG. 3A;

FIG. 4A is a front perspective view of a single phase of an inline three-phase disconnect according to the present invention in the 75% partially open position;

FIG. 4B is a front elevation view of FIG. 4A;

FIG. 5A is a front perspective view of a single phase of an inline three-phase disconnect according to the present invention in the fully open position;

FIG. 5B is a front elevation view of FIG. 5A;

FIG. 6 is an elevation view of the inline switches in the closed position;

FIG. 7 is an elevation view of the inline switches in the open position;

FIG. 8 is a top view of the inline switches in a 3-way configuration;

FIG. 9 is a front perspective view of a single phase of an inline three-phase disconnect according to the present invention in the fully closed position with the shielding removed exposing internal components;

FIG. 10 is a perspective view of the inline disconnect of FIG. 9 with a zoomed in view of the control box;

FIG. 11 is a perspective view of the inline disconnect of FIG. 9 with a zoomed in view of the load break housing; and

FIG. 12 is a front view of the inline disconnect of FIG. 9 with a zoomed in view of the load break housing with the protective cover removed.

### DETAILED DESCRIPTION

In view of the foregoing needs, the present invention includes apparatuses, systems, and methods including an inline disconnect component for multiphase electric utility applications. One system may include an inline, load break multi three-phase disconnect component for an electric utility line component. In one embodiment, the load break disconnect component may include load break vacuum bottle interrupters that are mounted axially inline with a switch blade to substitute or replace more traditional switches that operate based upon mechanical rotation. One or more load break vacuum bottles may be arranged in series and/or in parallel to permit switching at a desired voltage rating. A vacuum interrupter column may hang parallel beneath a traditional strain insulator and/or conductor and may move inline with the switch as it operates. This inline switch may then be placed in series with another strain insulator, thus allowing the line to be insulated to ground.

In another embodiment, a group-operated switching system for multi-phase electrical transmission lines including a plurality of inline axial switches; a plurality of electrical transmission lines, each of the inline axial switches being disposed within one of the transmission lines for selective opening and closing, each of the inline axial switches having at least one load break vacuum interrupter operable to control electrical flow through one of the electrical transmission lines; and a control box connected to the plurality of inline axial switches via radio frequency transmission and reception, for controlling operation of the plurality of inline axial switches and providing status information to a user. In this embodiment, each of the plurality of inline axial switches may have an electronic component for controlling operation and providing status information; and wherein the plurality of inline axial switches are adapted for group operation and are mechanically and electrically isolated from each other and from the control box.

In another embodiment, the inline axial switches described above may include a motorized cabinet for actuating the one inline axial switch. Further, the motorized cabinet and inline axial switch electronic component may be powered from line power, from line power using a current transformer, from a battery, or from a capacitive source.

In still another embodiment, the load break load break vacuum interrupter 401 described above is operable in high-voltage, high-current load conditions.

In yet another embodiment, a switching system for an electrical transmission line may including an inline switch disposed within a transmission line for selective opening and closing, the inline switch having at least one load break vacuum interrupter electronically operable to control electrical flow through the transmission line; and a control box connected to the inline switch via radio frequency transmission and reception, for controlling operation of the inline switch and providing status information to a user; wherein the inline switch is mechanically and electrically isolated from the control. In this embodiment, the inline switch may include a motorized cabinet for actuating the at least one load break vacuum interrupter; and switch electronics for communicating with the control box and for controlling the motorized cabinet.

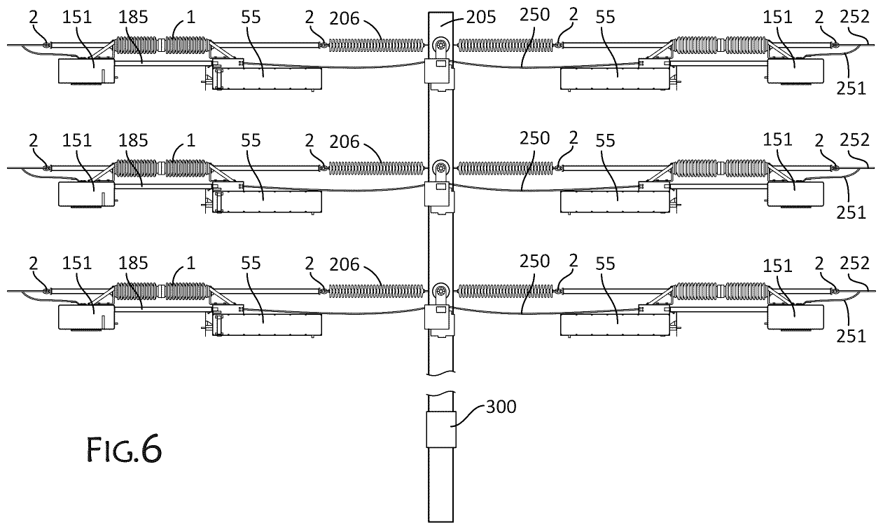

In still another embodiment, an improved arrangement for group-operated switches for electrical transmission lines, includes: a) a utility pole for supporting a plurality of electrical transmission lines; b) a plurality of first strain insulators for insulating the plurality of electrical transmission lines to ground, each of the first strain insulators being connected to the pole; c) a plurality of second strain insulators, each of the second strain insulators being connected to one of the first strain insulators and one of the electrical transmission lines; d) a plurality of inline switches, each disposed within one of the electrical transmission lines and each being connected across one of the second strain insulators; and e) a control box disposed at the utility pole, for controlling, through RF communications, operation of the plurality of inline switches to control electrical flow through the plurality of electrical transmission lines; each of the plurality of inline switches including at least one vacuum interrupter for selectively opening or closing a circuit that includes the electrical transmission line upon which the inline switch operates, each of the plurality of inline switches including a motorized cabinet housing, a gear drive mechanism 303 for actuating the load break vacuum interrupter 401, and control electronics for communicating with the control box 300 and controlling the gear drive mechanism 303, and each of the plurality of inline switches being electrically and mechanically isolated from the other inline switches and from the control box 300 (See for example, FIG. 6). In this embodiment, each of the inline switches includes a gear drive mechanism 303 housed in a motorized cabinet for actuating the inline switch.

Referring to FIG. 6, each line for which group-operated switching may be provided with a switch arrangement. The chief advantage of using a switch arrangement of this type is the elimination of the mechanical linkage between switches. Instead of a moving mechanical linkage, the stacked vacuum interrupter bottles housed within the interrupter housing 55 may be activated by the movement of a non-rotating blade that may be driven axially by a motorized cabinet 151. An RF transmitter-receiver combination may be used both for status indication (open or closed) and control (open or close) of the gear drive mechanism.

In an additional feature of the invention, the power for system electronics and gear drive mechanism actuation may come from a capacitive source, a silicon-iron core current transformer, batteries, power over fiber, or a capacitor. Depending upon the particulars of the configuration and usage, this feature may permit the system to be charged from line power as well as solar.

In operation, each of the three phase sets may be mechanically and electrically isolated from the other phase sets. Each set may include a set of switches in communication with a transceiver. At the base of a pole, a control box may coordinate operation of all three phases simultaneously, via RF-based communications. In the event of a failure of one of the three phases, the control box may be configured and programmed to return the operational phases to the same open or closed state as the failed unit. A remote contact may be provided to a remote telemetry unit or other communications device in order to transfer the failure status information to a supervisory control and data acquisition (SCADA) system.

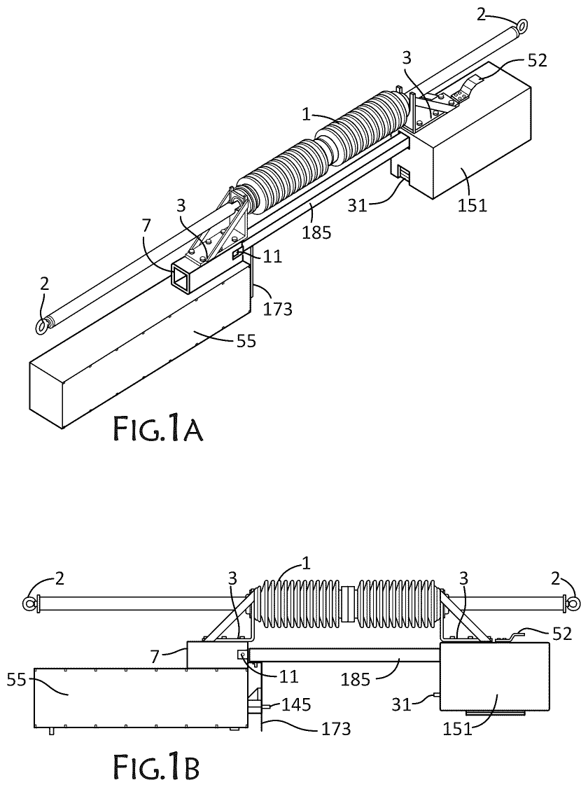

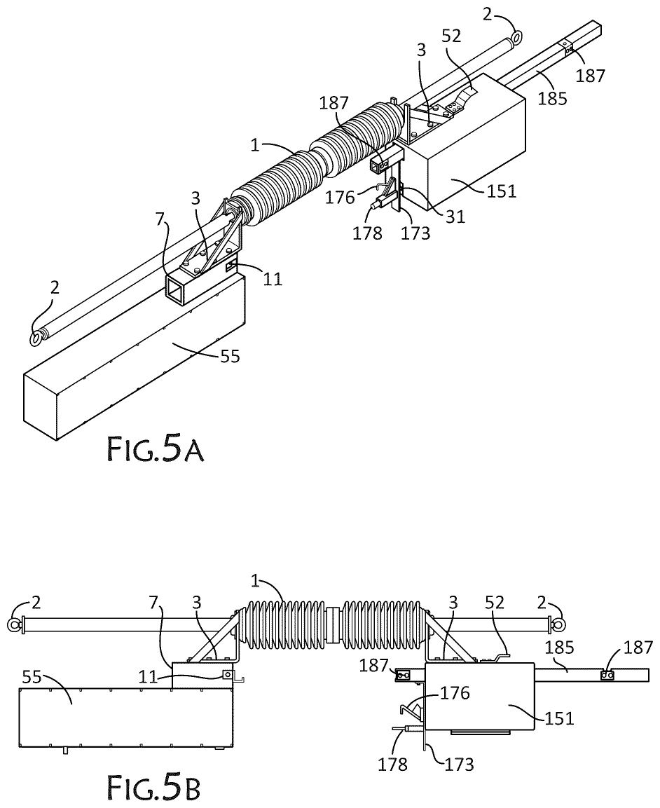

Referring now to the drawings, FIGS. 1A-5B illustrate one embodiment of the present system, which includes the sequence of operation of a disconnect blade 185 and an interrupter 87. In the example an insulator 1 is shown During operational cycles from the closed state to the open state and the reverse cycle of the open state to the closed state all mechanical linkages stay in the same clearance envelope while traveling inline with the original orientation. This movement is critical in keeping balanced line loads as well as clearance air gaps between circuit legs during operational cycles.

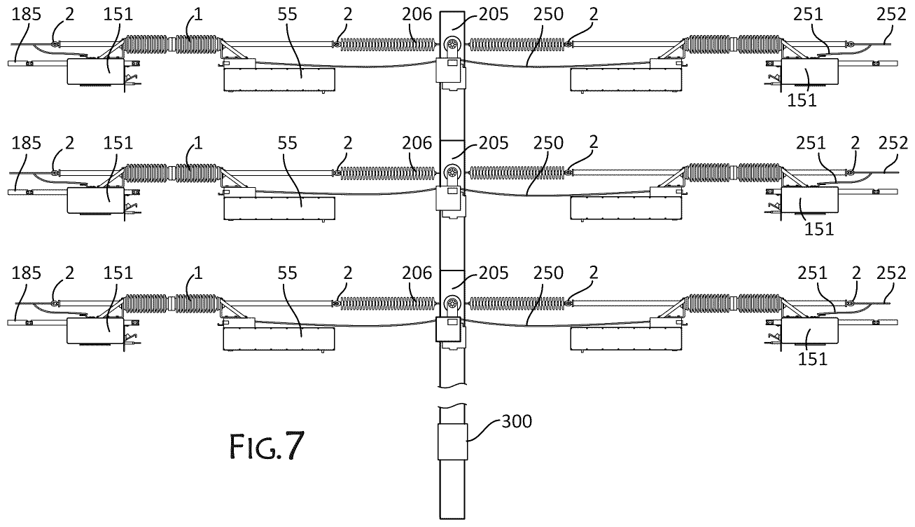

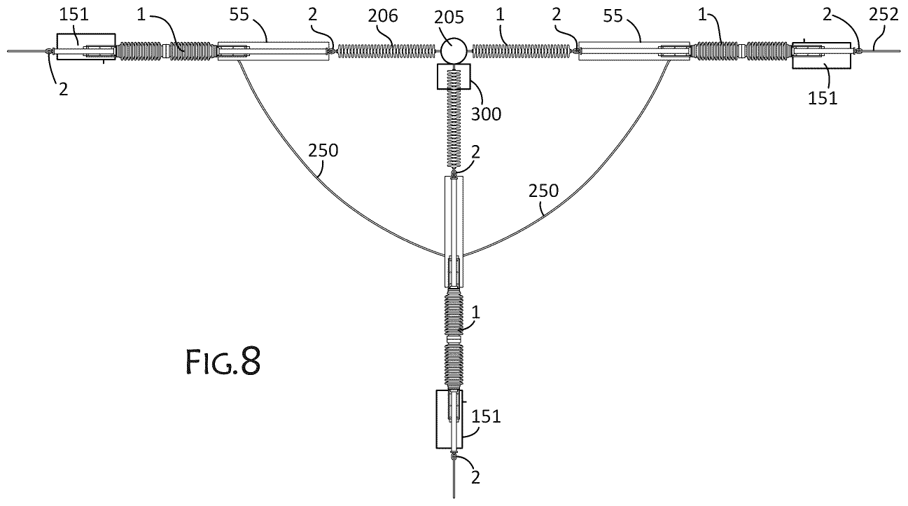

Skipping briefly to FIG. 6, illustrating the general arrangement of an inline disconnect on a multi-phase utility line according to the present invention. A utility pole 205 carries electrical lines 250, 251, 252 each associated with one of three phases I, II, III of AC electric power. Each line is attached to the utility pole 205 and insulated from ground using three strain insulators 206. The current path enters the pole region and travels through the disconnect blade 185 that has been connected across an outermost strain insulator 1. This disconnect blade 185 provides an open air gap (701) and thus a visual indicator that the line has been disconnected and the circuit broken as shown in FIG. 7. When the disconnect blade 185 is closed as shown in FIG. 6, current may travel through and exit to terminal pad connection 52. The inline interrupter 87 is not in the circuit when the disconnect blade 185 is closed. A plurality of disconnect blades 185 may be conveniently grouped into switch groups A, B, and C, each associated with a run of transmission lines (See FIGS. 6-8).

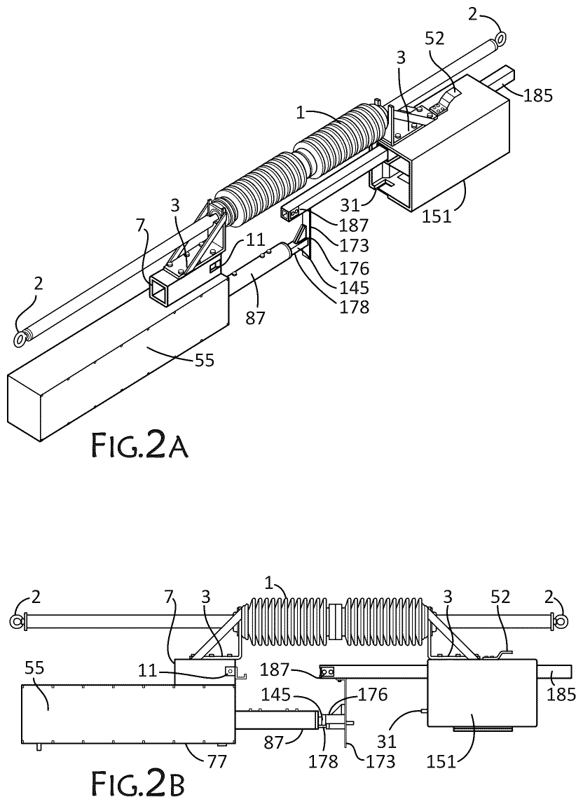

In the example of FIGS. 2A-B, the load break vacuum interrupter 87 is housed an interrupter housing to protect the contents and mechanisms, and includes a set of 38 kV load break vacuum bottles having up to 3000 A current ratings. These vacuum bottles are arranged in series and allow up to 230 kV switching or greater, in accordance with industry requirements. Vacuum bottles may also be arranged in parallel to permit higher current ratings if required. The stacked vacuum interrupter bottles are activated by a toggle mechanism that actuates based on switch travel from the motorized cabinet to open and close the vacuum contacts. The motorized cabinet 151 is powered from one of several possible sources, such as a capacitive source (appropriate in conditions of high voltage but no current), a silicon-iron core current transformer (appropriate in conditions where current and voltage are available from the electric line), a battery (appropriate for solar applications), a capacitor, or a combination of the listed sources.

The motorized cabinet 151 (schematically depicted in the drawings) is provided with an RF transceiver that is configured to transmit signals regarding the status of the switch (i.e., open or closed) as well as to receive control signals from a wireless control box 300 located in an accessible position on the pole. Power for the electronics may also be provided from the same source as power for the motorized cabinet 151. This arrangement permits the switch to be powered from a storage source regardless of the availability of line power, although when line power is usually available (such as when a switch is normally closed), charging the storage source from line power is preferred. Because the time required to charge the storage source may be quite long, the storage source should be selected so as to permit a large number of operational cycles.

The transceiver described above is configured to be in communication with the wireless control box 300. The wireless control box 300 is configured to receive RF signals from each of the switches under its control. These RF signals indicate whether the switch is open or closed. The wireless control box 300 is also configured to transmit RF signals to each of the switches under its control, to actuate the gear drives to close or open the switches as a group, depending upon the desired state of operation. This arrangement also affords a degree of error-checking, in that a switch that is in the incorrect position due to a failure of some sort will report the failure to its wireless control box 300. The wireless control box 300 may then return the operational phases to the same state, open or closed, as the failed unit. This error state may also be reported to a remote telemetry unit or to SCADA unit for further handling.

In this manner, an inline three-phase disconnect (See FIGS. 6 and 7) for electrical utility line applications may be conveniently and economically provided. Because this arrangement is mechanically and electrically isolated with respect to each current phase, the need for elaborate insulation schemes and support structures is greatly reduced if not eliminated. Moreover, because the operation of the group of switches is not limited to configurations that can be conveniently mechanically linked for group operation, little if any site-specific application engineering is required. These factors also greatly reduce the time required to plan and install switches of this type and use, which results in a labor and downtime savings to the electric utility.

In another embodiment, a group-operated switching system for multi-phase electrical transmission lines including a plurality of inline axial switches. In said embodiment, a plurality of electrical transmission lines is provided, wherein the inline axial switches being disposed within each of the transmission lines for selective opening and closing, each of the inline axial switches having at least one load break vacuum interrupter operable to control electrical flow through one of the electrical transmission lines. The system further comprises a wireless control box 300 connected to the plurality of inline axial switches via radio frequency transmission and reception, for controlling operation of the plurality of inline axial switches and providing status information to a user. In this embodiment, each of the plurality of inline axial switches may have an electronic component for controlling operation and providing status information; and wherein the plurality of inline axial switches are adapted for group operation and are mechanically and electrically isolated from each other and from the control box.

In another embodiment, the inline axial switches described above may include a motorized cabinet for actuating the one inline axial switch. Further, the motorized cabinet and inline axial switch electronic component may be powered from line power, from line power using a current transformer, from a battery, or from a capacitive source.

In still another embodiment, the load break vacuum interrupter described above is operable in high-voltage, high-current load conditions.

In yet another embodiment, a switching system for an electrical transmission line may including include an inline switch disposed within a transmission line for selective opening and closing, the inline switch having at least one load break load break vacuum interrupter 401 electronically operable to control electrical flow through the transmission line; and a control box 300 connected to the inline switch via radio frequency transmission and reception, for controlling operation of the inline switch and providing status information to a user; wherein the inline switch is mechanically and electrically isolated from the control. In this embodiment, the inline switch may include a motorized cabinet for actuating the at least one load break vacuum interrupter; and switch electronics 301 for communicating with the control box 300 and for controlling the motorized cabinet.

In still another embodiment, an improved arrangement for group-operated switches for electrical transmission lines, includes: a) a utility pole for supporting a plurality of electrical transmission lines; b) a plurality of first strain insulators for insulating the plurality of electrical transmission lines to ground, each of the first strain insulators being connected to the pole; c) a plurality of second strain insulators, each of the second strain insulators being connected to one of the first strain insulators and one of the electrical transmission lines; d) a plurality of inline switches, each disposed within one of the electrical transmission lines and each being connected across one of the second strain insulators; and e) a control box disposed at the utility pole, for controlling, through RF communications, operation of the plurality of inline switches to control electrical flow through the plurality of electrical transmission lines; each of the plurality of inline switches including at least one vacuum interrupter for selectively opening or closing a circuit that includes the electrical transmission line upon which the inline switch operates, each of the plurality of inline switches including a motorized cabinet housing, a gear drive mechanism for actuating the vacuum interrupter, and control electronics for communicating with the control box and controlling the gear drive mechanism, and each of the plurality of inline switches being electrically and mechanically isolated from the other inline switches and from the control box. In this embodiment, each of the inline switches includes a gear drive mechanism housed in a motorized cabinet for actuating the inline switch.

Each line for which group-operated switching is required may be provided with a switch arrangement as provided above. The chief advantage of using a switch arrangement of this type is the elimination of the mechanical linkage between switches. Instead of a moving mechanical linkage, the stacked vacuum interrupter bottles may be activated by the movement of a non-rotating blade that may be driven axially by a motorized cabinet. An RF transmitter-receiver combination may be used both for status indication (open or closed) and control (open or close) of the gear drive mechanism.

In an additional feature of the invention, the power for system electronics and gear drive mechanism actuation may come from a capacitive source, a silicon-iron core current transformer, batteries, power over fiber, or a capacitor. Depending upon the particulars of the configuration and usage, this feature may permit the system to be charged from line power as well as solar.

In operation, each of the three phase sets may be mechanically and electrically isolated from the other phase sets. Each set may include a set of switches in communication with a transceiver. At the base of a pole, a control box may coordinate operation of all three phases simultaneously, via RF-based communications. In the event of a failure of one of the three phases, the control box may be configured and programmed to return the operational phases to the same open or closed state as the failed unit. A remote contact may be provided to a remote telemetry unit or other communications device in order to transfer the failure status information to a supervisory control and data acquisition (SCADA) system.

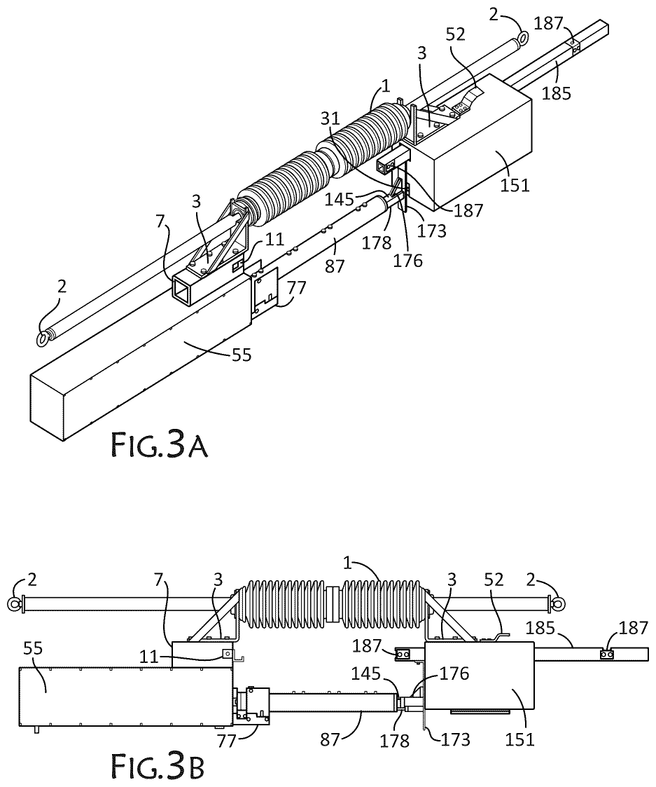

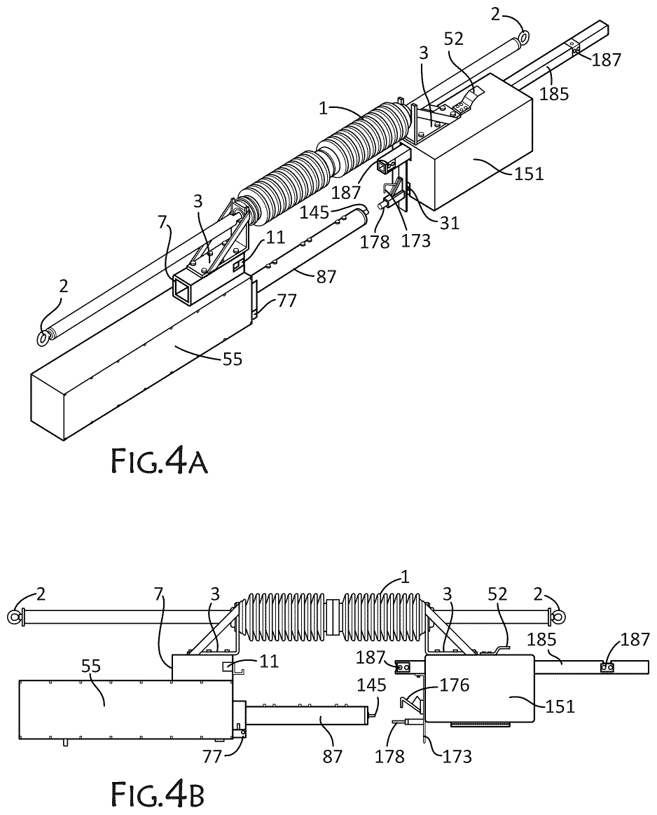

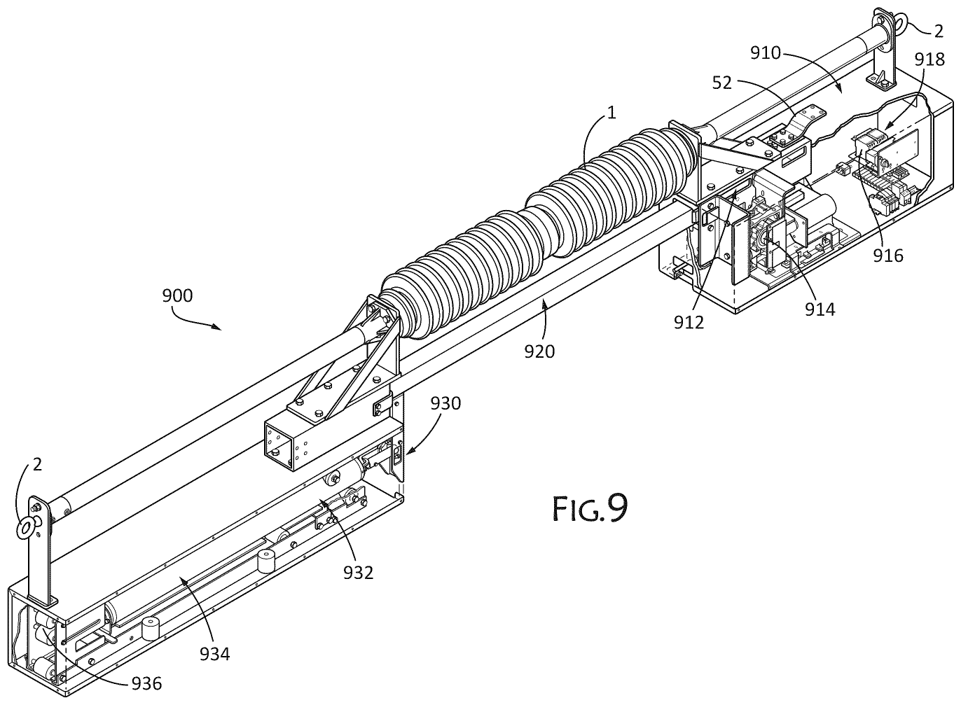

Referring generally to FIGS. 9-12, disclosed is an inline disconnect 900 for electrical transmission lines, including: a motorized cabinet 910, with an terminal pad 911 on the exterior. The motorized cabinet 910 comprising a power source 912, switch electronics 916, a gear drive 914 connected to a disconnect blade 920 for axial movement, the disconnect blade 920 further including an interrupter bracket 173 and catch mechanism 176, and a catch release hook 31 (See FIGS. 3B-4B). The disconnect blade 920 when being retracted pulls the load break vacuum interrupter 932 outside of the interrupter housing 930, and when the disconnect blade 920 reaches a set threshold, the catch mechanism 176 releases the catch hook 31, which disconnects electrical flow, causing the load break vacuum interrupter 932 to return to its housing via the constant force springs 936 and the guide rollers 938. Thereby safely disconnecting utility transmission lines, and providing a visible air gap.

The disclosure herein provides a control box 300 at ground level, typically attached to a utility pole 205, the control box 300 includes a wireless communication radio to signal to the switch electronics 916, to trigger the electrical switch 918, to protract or retract the disconnect blade 185, 920 with the gear drive 914. The signaling may occur via radio transmission, and alleviates the need for a utility worker to perform a climb or otherwise utilize a bucket truck to engage the inline disconnect. Continuing, a load break vacuum interrupter 932 resides inside an interrupter housing 930, the load break vacuum interrupter 932 including load break vacuum bottles 934 are held into the housing with a constant force spring 936 and guide rollers 938 to allow the load break vacuum interrupter 932 to move axially from the interrupter housing 930 when the disconnect blade 920 retracts. The load break vacuum interrupter 932 is electrically connected to the disconnect blade 920 through the vacuum interrupter lead 145 (See FIGS. 2B and 3B) making surface contact to a disconnect blade lead 178.

Continuing, in some aspects, switch electronics 916 within the motorized cabinet 910 further include wireless transmission for communicating with the control box 300 and for controlling the motorized cabinet 910, wherein controlling moves the disconnect blade 920 axially to connect/disconnect through the load break vacuum interrupter 932. Further, the disconnect blade 920, coupled with the interrupter bracket 173 (See also FIG. 2B) and catch mechanism 176 (See also FIG. 2B) holds the load break vacuum interrupter 932 in electrical contact with the disconnect blade 920. Additionally, the disconnect blade 920 has multiple disconnect blade contact points 187 (See FIGS. 3A-B) for electrical connection. In one aspect the vacuum interrupter lead 145 is in electrical contact with at least one disconnect blade contact point 187 when the disconnect blade is in a closed state or resting state with electrical current flowing, and no air gap. Additionally, the inline disconnect may also include a jaw contact 11 (See FIGS. 2B, 3B) on the interrupter housing 930 for connecting with one of the disconnect blade contact points 187 (See FIGS. 3A-B). Thus allowing electrical current to flow through the disconnect blade through to the jaw contact and allow for engaging of the same. An additional feature includes a terminal pad 911 on the motorized cabinet 910 for receiving electrical current. Lastly, additional features within the system include a pull off 2, a pull off bracket 3, and an insulator 1 (See, for example, FIG. 1A).

Focusing now on the motorized cabinet 910, which includes the gear drive 914, and switch electronics 916. In one aspect, the switch electronics 916 and the gear drive 914 are power by a power source 912 such as a battery, or other power sources such as a solar panel or direct line power.

Continuing with FIGS. 9-12, an example inline disconnect 900 for a multiphase utility wire. In the example, FIG. 9 discloses a front perspective view of a single phase of an inline disconnect 900 according to the present invention in the fully closed position with the shielding removed exposing internal components. In the example, the motorized cabinet 910 houses the electrical switch 918 and switch electronics 916 that allows for the signaling or communication to initiate the gear drive 914 for withdrawing the capacitive source (sometimes referred to as a disconnect blade) 920 to create an air gap in the wire utility wire. In the example, the motorized cabinet 910 houses the electrical and mechanical components to linearly move the disconnect blade 920 to break the connection and form an air gap. The motorized cabinet 910 comprises an electrical switch 918 that is operated through switch electronics 916 that comprise a radio frequency antennae, and allows for communication over radio including cellular communications. The switch electronics 916, in one aspect, further comprise computing infrastructure, such as a microcontroller, that allows for signals to be received and to trigger the electrical switch 918 that initiates the gear drive 914 for moving linearly the disconnect blade 920. The switch electronics 916, and the gear drive 914 may be powered from a power source 912, such as a battery, or through a separate direct power source. The disconnect blade 920, once driven linearly with the gear drive 914 creates physical separation (air gap) in the circuit that allows for complete electrical isolation, which allows for visible separation and prevention of capacitive or induced voltage sources from entering the circuit. In driving the disconnect blade 920, a degree of separation is determined to prevent arcing across the contacts.

The interrupter housing 930 includes the load break vacuum interrupter 932, and the load break vacuum bottles 934. The load break vacuum interrupter 932 operates to interrupt current flow under load conditions, when the disconnect blade 920 is withdrawn from the circuit, the load break vacuum interrupter aids in preventing an electrical arc that may form when the circuit is broken. The load break vacuum interrupter 932 comprises load break vacuum bottles 934 that contain a vacuum environment to interrupt the current to allow for safe opening of the circuit.

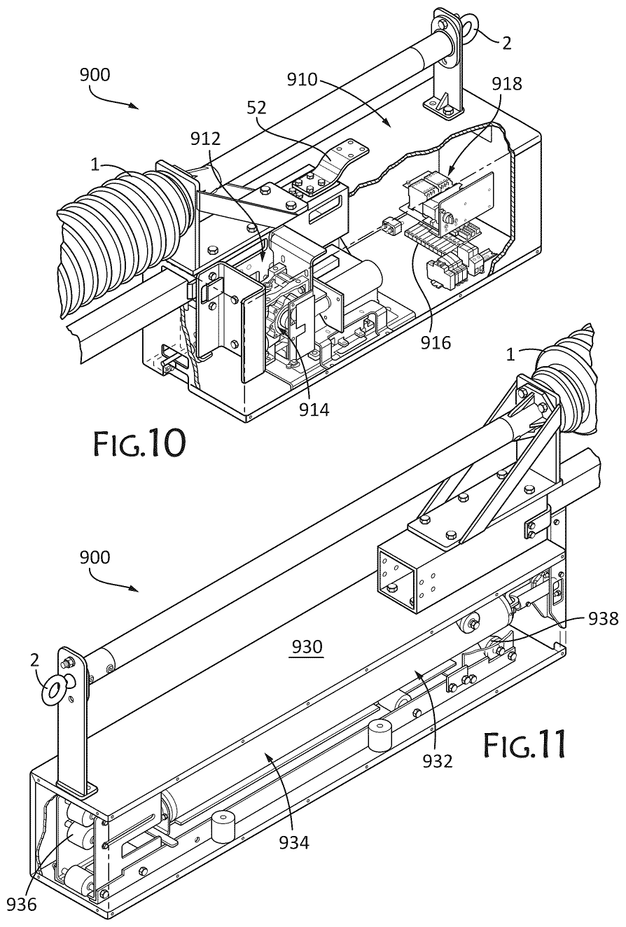

Referring now to FIG. 10, a perspective view of the inline disconnect 900 of FIG. 9 with a zoomed in view of the motorized cabinet 910. Inside the motorized cabinet 910 is a mechanical gear drive 914, that may comprise a worm gear, a hypoid gear, a bevel gear, or helical gears with crossed axes. The motorized cabinet 910 serves to hold the circuitry and switch electronics 916 to direct the electrical switch 918 to initiate the gear drive 914 to linearly move the capacitive source (not pictured). The power source 912 provides the power source to operate the gear drive 914 and the switch electronics 916.

Referring now to FIG. 11, a perspective view of the inline disconnect 900 of FIG. 9 with a zoomed in view of the load break housing. In the example, the interrupter housing 930 holds the load break vacuum interrupter 932 that is comprised of one or more load break vacuum bottles 934 to serve as a vacuum environment for absorbing the current when the circuit is broke through the gear drive 914 (FIG. 10) removing the capacitive source (not shown).

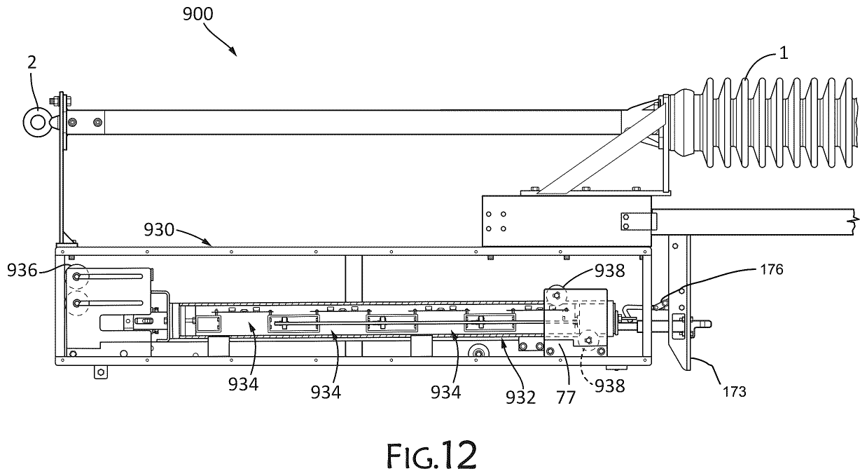

Referring now to FIG. 12, a front view of the inline disconnect 900 of FIG. 9 with a zoomed in view of the interrupter housing 930 with the protective cover removed from the load break vacuum interrupter 932. In the example a plurality of load break vacuum bottles 934 are disclosed, allowing for increased voltage withstand capability, and is used in applications typically above 15 kV. The multiple load break vacuum bottles 934 increase reliability and arc quenching margin, providing additional protection from arcing across the air gap created by the removal of the conductive source by the control box interacting with the gear drive.

In view of the aforesaid written description of the present invention, it will be readily understood by those persons skilled in the art that the present invention is susceptible of broad utility and application. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention.

Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

Therefore, we claim:

1. An inline disconnect for electrical transmission lines, comprising:
a motorized cabinet, comprising a power source, switch electronics, a gear drive connected to a disconnect blade for axial movement, the disconnect blade further comprising an interrupter bracket and catch;
a control box at ground level, the control box comprising a wireless communication radio to signal to the switch electronics to protract or retract the disconnect blade with the gear drive; and
a load break vacuum interrupter inside an interrupter housing, the load break vacuum interrupter comprising load break vacuum bottles and a constant force spring and guide rollers to allow the load break vacuum interrupter to move axially from the interrupter housing when the disconnect blade retracts.

2. The inline disconnect of claim 1, wherein the switch electronics further comprise wireless transmission for communicating with the control box and for controlling the motorized cabinet.

3. The inline disconnect of claim 1, wherein the disconnect blade with the interrupter bracket and a catch mechanism holds the load break vacuum interrupter in electrical contact.

4. The inline disconnect of claim 1, wherein the disconnect blade has multiple disconnect blade contact points for electrical connection.

5. The inline disconnect of claim 4, further comprising a jaw contact on the interrupter housing for connecting with one of the disconnect blade contact points.

6. The inline disconnect of claim 1, further comprising a terminal pad on the motorized cabinet.

7. The inline disconnect of claim 1, further comprising a pull off, a pull off bracket, and an insulator.

8. The inline disconnect of claim 1, wherein the power source for the gear drive is a battery.

9. The inline disconnect of claim 1, wherein the disconnect blade is fully retracted and the interrupter is returned to the interrupter housing creates an air gap and a visual identifier of the disconnect of power.

10. The inline disconnect of claim 1, wherein the disconnect blade catch is engaged with the load break vacuum interrupter and is released when the disconnect blade is fully retracted.

11. A method of deploying an inline disconnect for electrical transmission lines, comprising:
providing a motorized cabinet, comprising a power source, switch electronics, a gear drive connected to a disconnect blade for axial movement, the disconnect blade further comprising an interrupter bracket and catch;
providing a control box at ground level, the control box comprising a wireless communication radio to signal to the switch electronics to protract or retract the disconnect blade with the gear drive;
providing a load break vacuum interrupter inside an interrupter housing, the load break vacuum interrupter comprising load break vacuum bottles and a constant force spring and guide rollers to allow the load break vacuum interrupter to move axially from the interrupter housing when the disconnect blade retracts;
retracting axially the disconnect blade, which pulls the load break vacuum interrupter; and
releasing the catch on the disconnect blade, allowing the load break vacuum interrupter to retract from the constant force spring back into the interrupter housing.

12. The method of claim 11, wherein the switch electronics further comprise wireless transmission for communicating with the control box and for controlling the motorized cabinet.

13. The method of claim 11, wherein the disconnect blade with the interrupter bracket and a catch mechanism holds the load break vacuum interrupter in electrical contact.

14. The method of claim 11, wherein the disconnect blade has multiple disconnect blade contact points for electrical connection.

15. The method of claim 14, further comprising a jaw contact on the interrupter housing disengaging with one of the disconnect blade contact points, when the disconnect blade retracts.

16. The method of claim 11, further comprising a terminal pad on the motorized cabinet.

17. The method of claim 11, further comprising providing a pull off, a pull off bracket, and an insulator.

18. The method of claim 11, wherein the power source for the gear drive is a battery.

19. The method of claim 11, wherein when the disconnect blade is fully retracted and the load break vacuum interrupter is returned to the interrupter housing creates an air gap and a visual identifier of disconnecting power transmission.

20. The method of claim 11, wherein the disconnect blade through a catch mechanism is engaged with the load break vacuum interrupter and is released when the disconnect blade is fully retracted.
